(19) United States
(12) Patent Application Publication
(10) Pub. No.: US 2015/0375236 A1
(43) Pub. Date: Dec. 31, 2015

(54) HEAVY METAL RECOVERY SYSTEM AND APPARATUS

(71) Applicant: Brandon V. Dietrich, Grand Rapids, MI (US)

(72) Inventor: Brandon V. Dietrich, Grand Rapids, MI (US)

(21) Appl. No.: 14/746,964

(22) Filed: Jun. 23, 2015

Related U.S. Application Data
(60) Provisional application No. 62/016,978, filed on Jun. 25, 2014.

(51) Int. Cl. B03B 7/00; B03B 11/00; B03B 5/28; B07B 1/28; C22B 1/00; C22B 11/00

(52) U.S. Cl. CPC B03B 7/00; C22B 1/00; C22B 11/00; B03B 5/28; B07B 1/28; B03B 11/00

(57) ABSTRACT

The heavy metal recovery apparatus includes a container having a cavity defined by a bottom element and a wall extending upwards from the bottom element, with the container having input and output ends. The bottom element includes an upper portion and a lower portion with a chamber therebetween, with a plurality of apertures formed in the upper portion, with the bottom element sloping downward from the input end to the output end. The container may be mounted within a frame with security panels mounted to the frame to prevent unauthorized access to the container.

### CROSS REFERENCE TO RELATED APPLICATION

The present application claims priority of U.S. provisional application Ser. No. 62/016,978 filed Jun. 25, 2014, by Brandon V. Dietrich for HEAVY METAL RECOVERY SYSTEM AND APPARATUS, which is hereby incorporated herein by reference in its entirety

### BACKGROUND AND FIELD OF THE INVENTION

The present invention relates generally to mining equipment and, more particularly, to equipment and a method for separating minerals from a fluid mixture.

Precious metals, such as gold, are often found in rock and soil deposits and need to be extracted. Mined earth may be combined with generous amounts of water and agitated to cause separation of the commercially worthless material, such as mud and sand, from the precious metals. The higher density precious metals settle to the bottom for collection while the lighter material is washed away with the water.

### SUMMARY OF THE INVENTION

The present invention provides an apparatus for recovering heavy metals and precious minerals from an earth and fluid mixture. The apparatus includes a container having a bottom element with a peripheral wall extending upwards from the bottom element. Together, the bottom element and peripheral wall define a cavity in which the material separation process occurs. The bottom element includes a plurality of through-hole apertures. Low pressure water enters the container cavity through the apertures and acts on the material in the fluid mixture, helping to separate the heavy metals and precious minerals from the lighter, commercially worthless material. The lighter material rises toward the surface and is discarded while the heavier material settles to the bottom for later collection. The apparatus may be combined with additional heavy metal recovery equipment as part of a heavy metal recovery system with the apparatus positioned at the output of a sluice box or other hydraulic mining system to recover precious metals that would otherwise be discarded. A method of recovering heavy metals thus involves processing earth and fluid through the apparatus, where the earth and fluid may be discharge from additional heavy metal processing equipment.

These and other objects, advantages, purposes and features of the present invention will become more apparent upon review of the following specification in conjunction with the drawings.

### BRIEF DESCRIPTION OF THE DRAWINGS

FIG. 1 is a perspective view of a heavy metal recovery apparatus in accordance with the present invention;

FIG. 2 is a left side elevation view of the heavy metal recovery apparatus of FIG. 1;

FIG. 3 is a right side elevation view of the heavy metal recovery apparatus of FIG. 1;

FIG. 4 is a rear elevation view of the heavy metal recovery apparatus of FIG. 1;

FIG. 5 is a front elevation view of the heavy metal recovery apparatus of FIG. 1;

FIG. 6 is a side sectional view of the heavy metal recovery apparatus of FIG. 1;

FIG. 7 is a perspective view of the heavy metal recovery apparatus of FIG. 1, shown with security panels installed to limit access to the internal portions of the apparatus;

FIG. 8 is a left side elevation view of the heavy metal recovery apparatus of FIG. 7;

FIG. 9 is a right side elevation view of the heavy metal recovery apparatus of FIG. 7;

FIG. 10 is a rear elevation view of the heavy metal recovery apparatus of FIG. 7;

FIG. 11 is a front elevation view of the heavy metal recovery apparatus of FIG.; and

FIG. 12 is a schematic view of a heavy metal recovery system with the apparatus of FIG. 1 disposed at an output of a hydraulic mining system.

### DESCRIPTION OF THE PREFERRED EMBODIMENTS

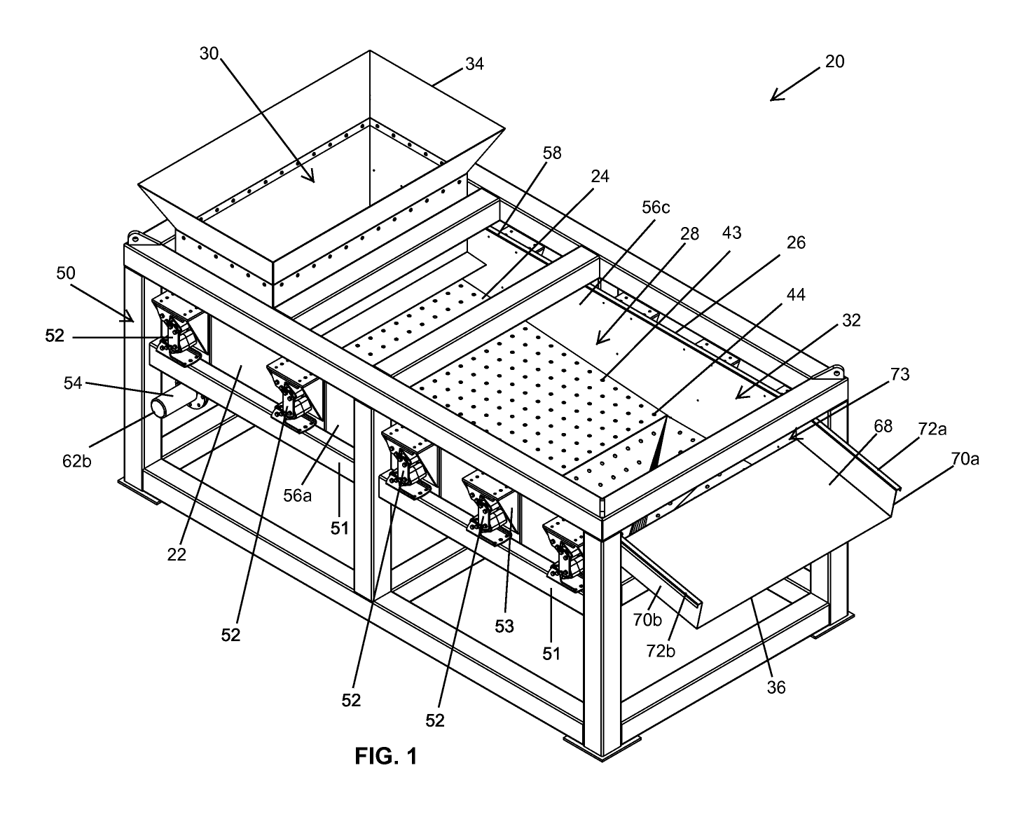

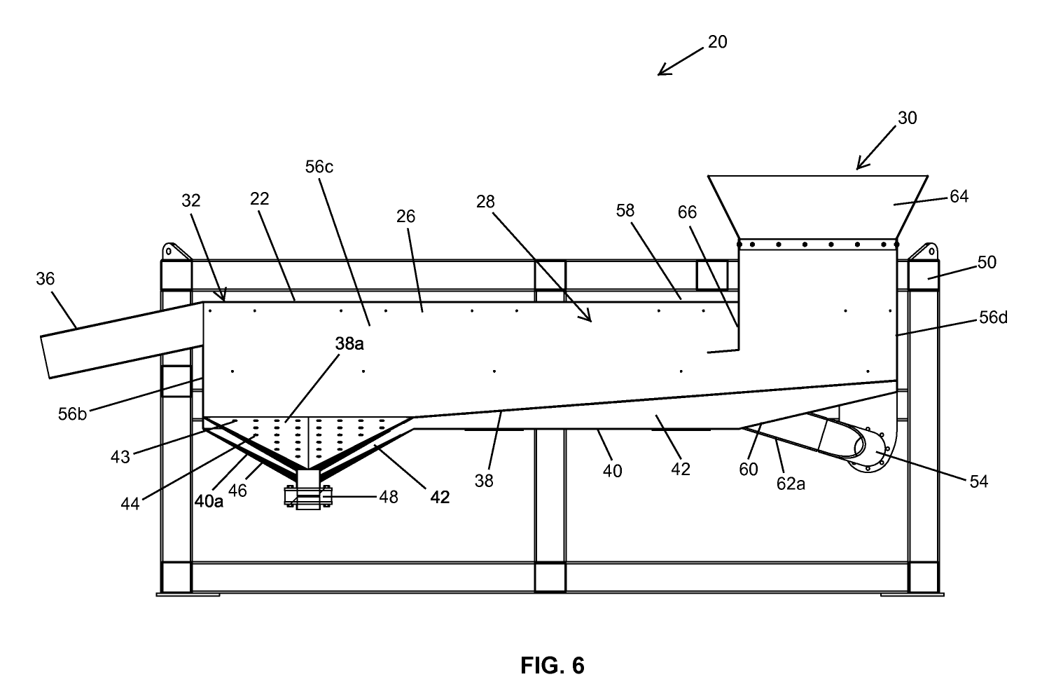

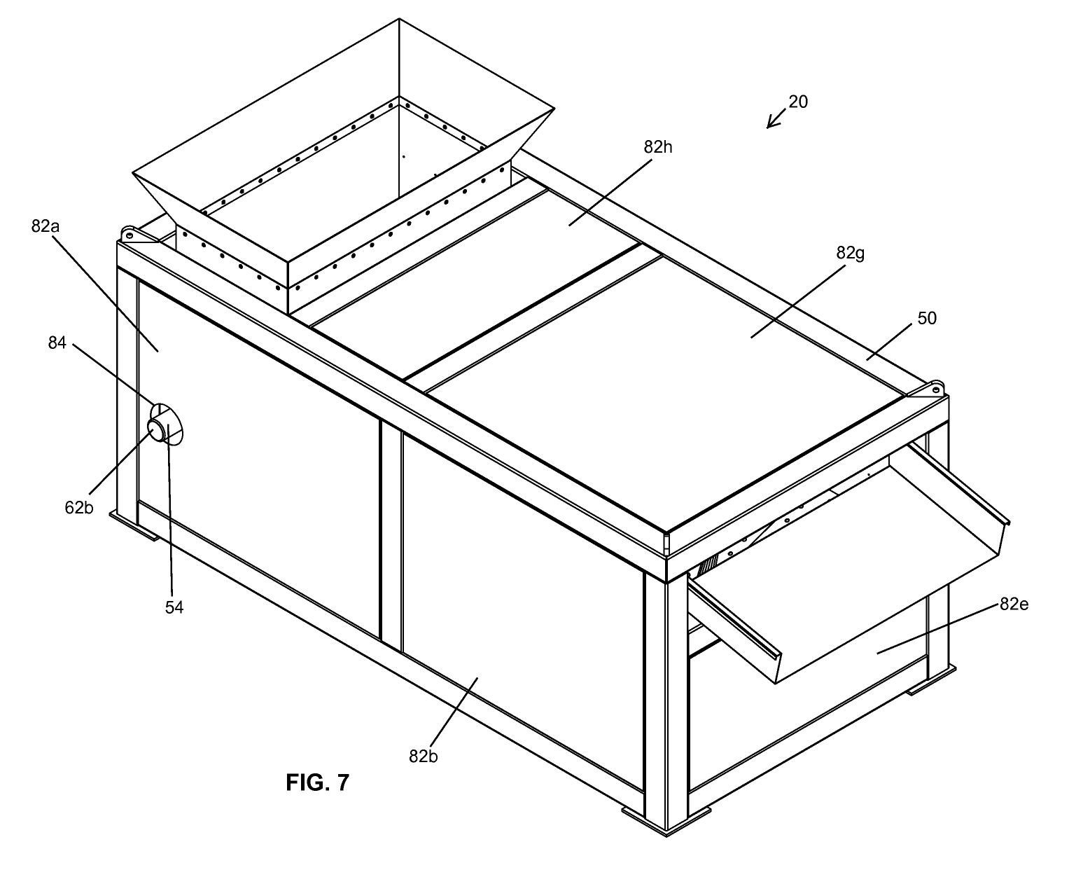

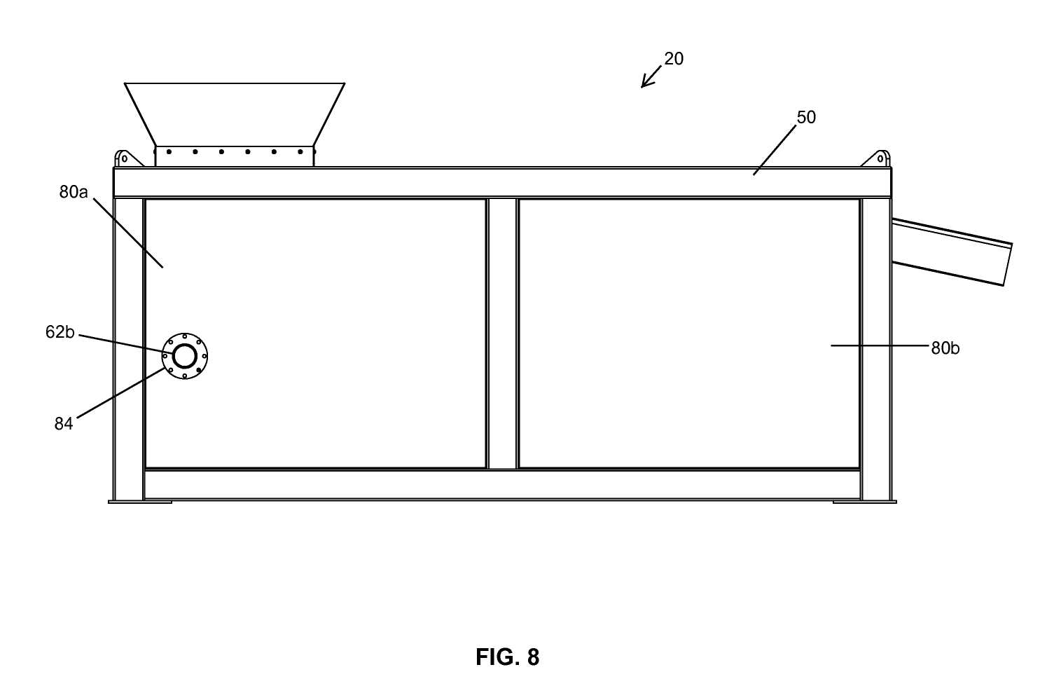

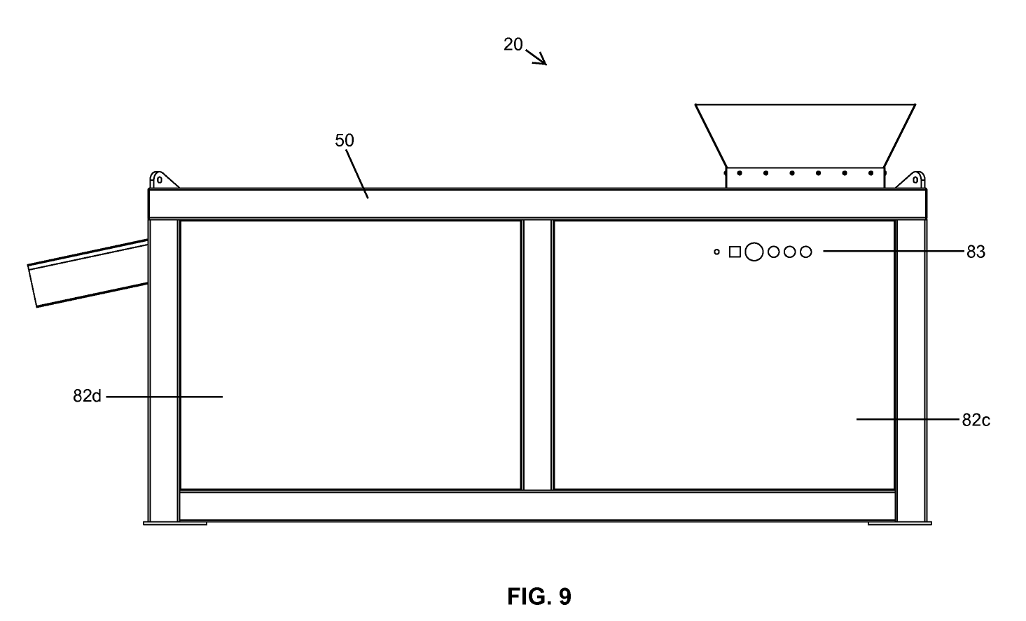

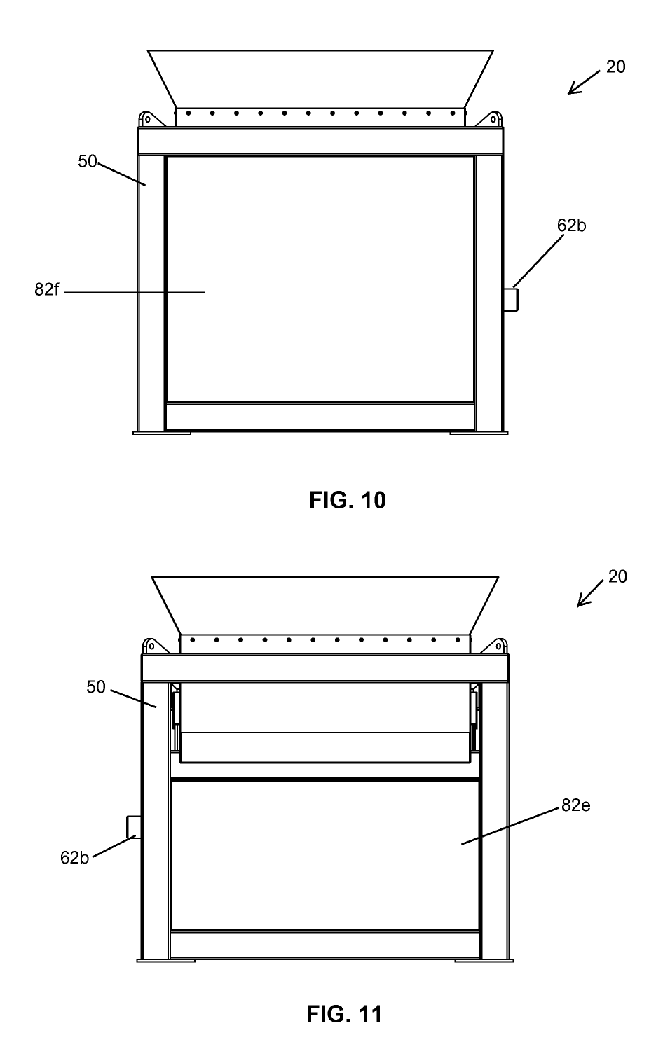

Referring now to the drawings and the illustrative embodiments depicted therein, a heavy metal recovery apparatus 20, as shown in FIGS. 1 and 6, comprises a container 22 having a bottom element or member 24 with a peripheral wall 26 extending up from and generally vertical to bottom element 24. Together, bottom element 24 and peripheral wall 26 define a cavity or receptacle 28 in which the material separation process occurs. At opposite ends of container 22 are an input end 30 and an output end 32. An input hopper 34 located at input end 30 helps to direct the flow of slurry material into cavity 28 while an output chute 36 allows water carrying the lighter, commercially worthless material to exit. Bottom element or assembly 24 is comprised of an upper portion or base or bottom member 38 and a lower portion or base or bottom member 40, with a water chamber 42 being formed between upper portion 38 and lower portion 40. Upper portion 38 is perforated to include a plurality of apertures 43 within which conventional pneumatic diffusers or nozzles comprising orifices may be installed therein. The diffusers introduce water into cavity 28 at a low pressure to aid in the material separation process as described in more detail below. In the illustrated embodiment, upper portion 38 of bottom element 24 slopes downward from input end 30 toward output end 32, terminating in a collection funnel 46 incorporated into bottom element 24 near output end 32, with the funnel 46 forming a collection chamber. Chamber 42 extends into funnel 46, with funnel 46 including an upper portion 38a and lower portion 40a connected with or formed as part of the upper portion 38 and lower portion 40, respectively. A butterfly valve 48 at the bottom of funnel 46 allows selective removal of the heavier materials that collect in funnel 46. Container 22 may mount to a frame or support structure 50 via a plurality of vibration mounts or pivot members 52, allowing container 22 to be shaken or oscillated relative to frame 50. As understood from FIGS. 7-11, one or more locking panels may be attached to frame 50 to prevent access to the collected precious material by unauthorized personnel.

During operation, a slurry mixture of water and mined earth enters cavity 28 through input hopper 34. The slurry mixture may be the discarded material from an upstream hydraulic mining system, such as a sluice box or the like, or may comprise an unprocessed slurry of earth and fluid. A motor shakes container 22, which in turn helps separate the lighter waste material from the heavier materials such as gold or other precious minerals as the mixture moves from input end 30 to output end 32. Water pumped into chamber 42 via an inlet pipe 54 enters cavity 28 under low pressure via diffusers 44 in upper portion 38 of bottom element 24. The low pressure water helps separate the heavier metals from the lighter mined earth material. The water introduced through diffusers 44 also helps move the heavier metals down the sloped bottom element 24 to collection funnel 46. The lighter waste material rises towards the surface of the water in cavity 28 and is discharged through chute 36.

In the illustrated embodiment, container 22 is generally a rectangular box having four sides 56a, 56b, 56c, and 56d extending upward from bottom element 24 and terminating at a top peripheral edge 58. Bottom element 24 is configured as a double bottom comprising upper portion 38 and lower portion 40. Lower portion 40 includes a hole or opening 60 positioned near input end 30 of container 22 and is configured to receive a first distal end 62a of inlet pipe 54. A second distal end 62b of inlet pipe 54 remains exposed for attachment to an external water supply, such as from a fluid pump.

Water supplied through inlet pipe 54 fills chamber 42 so that the water is distributed along the entire bottom surface of upper portion 38. Water in chamber 42 flows into cavity 28 through apertures 43 in upper portion 38. Pneumatic diffusers 44, such as, for example, sintered brass pneumatic diffusers, are installed in apertures 43. Diffusers 44 restrict the flow of water through apertures 43, allowing water from chamber 42 to bubble into cavity 28 at low velocity so as not to create turbulence that would stir up the slurry material and hinder the separation process. As discussed in more detail below, water from chamber 42 aids in the separation of materials and the movement of heavier particles to funnel 46 for collection. Upper portion 38 of bottom element 24 may slope downward from input end 30 to output end 32 so that heavier particles move more easily to funnel 46 while keeping apparatus 20 generally level.

Located at input end 30 of container 22 is input hopper 34. Hopper 34 includes a funnel element 64 and a generally L-shaped baffle 66. Baffle 66 extends downward from funnel element 64 into cavity 28. Baffle 66 promotes or creates a more orderly flow of input slurry material into cavity 28 by restricting the flow of material into cavity 28 and reducing the turbulence created in cavity 28 by the incoming slurry material.

Extending from output end 32 of container 22 is a generally U-shaped output chute 36 having a bottom portion 68 and a pair of sides 70a and 70b that terminate at edges 72a and 72b. Container 22 includes a recessed opening 73 for receiving one end of chute 36. Edges 72a, 72b of chute 36 are generally aligned with peripheral edge 58 of container 22 so that bottom portion 68 lies generally below the surface of the water in cavity 28. Chute 36 extends across the width of container 22 and slopes downward and away from container 22. As the lighter material rises to the surface of the water in cavity 28, the oscillation of the container 22 causes the water near the surface to be discharged down chute 36.

Positioned below chute 36 at output end 32 of container 22 is collection funnel 46. Funnel 46 is incorporated into bottom element 24 and serves as the final settling point for heavier material in the slurry mixture. As illustrated, funnel 46 is constructed to also include a lower portion and an upper portion with a plurality of apertures therein in like manner to the remainder of bottom assembly 24. As the input slurry material works its way from input end 30 to output end 32, oscillation of container 22 creates a stirring of the slurry material in cavity 28, which causes separation of the heavier minerals from the lighter waste material. Low pressure water though diffusers 44 aid in the material separation process and help bring the lighter material toward the water surface, where it exits container 22 via chute 36. The heavier material settles into collection funnel 46. Located at the bottom of funnel 46 is butterfly valve 48 or other suitable valve. When a sufficient quantity of heavy minerals have collected in funnel 46, butterfly valve 48 may be opened to empty funnel 46 of the collected material.

In the illustrated embodiment, collection funnel 46 is in the shape of an inverted pyramid. Alternatively, a conical or other suitably shaped collection chamber could be used. Double bottom chamber 42 and diffusers 44 extend into funnel 46. This allows separation and removal of lighter waste material to continue even after the material has settled into collection funnel 46.

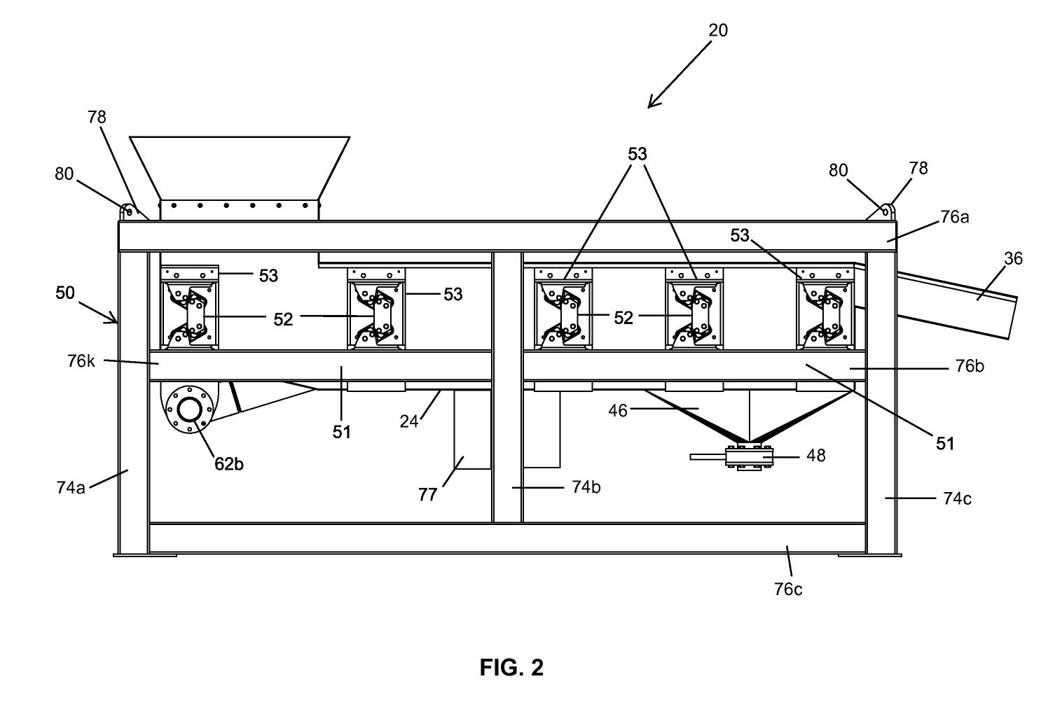

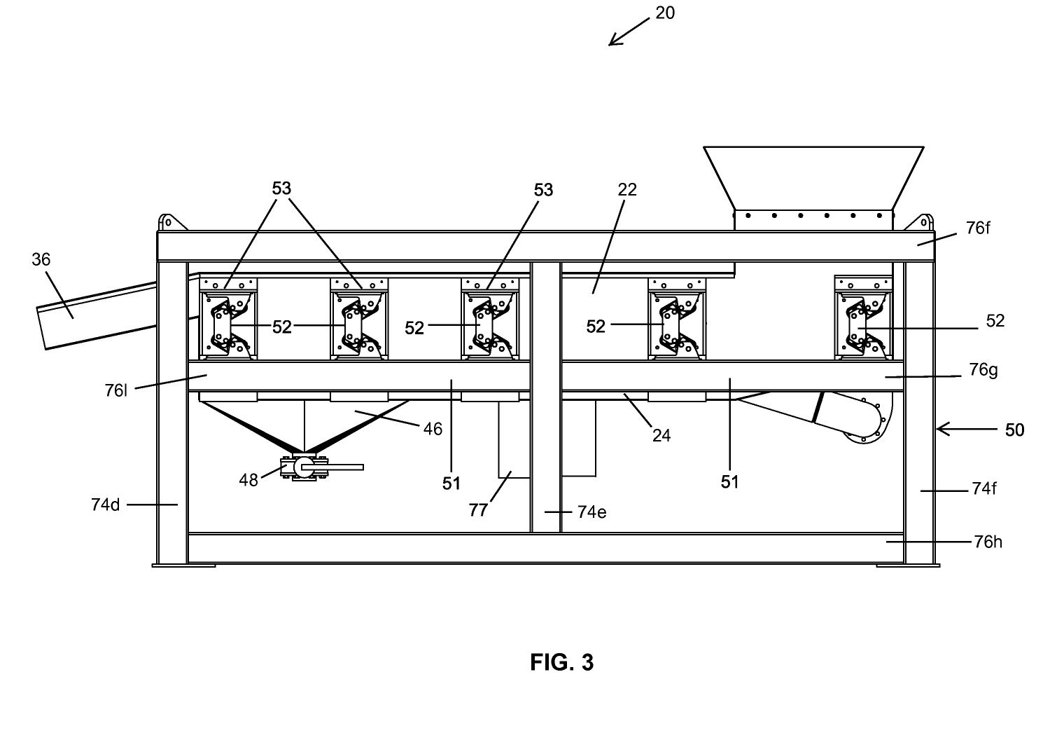

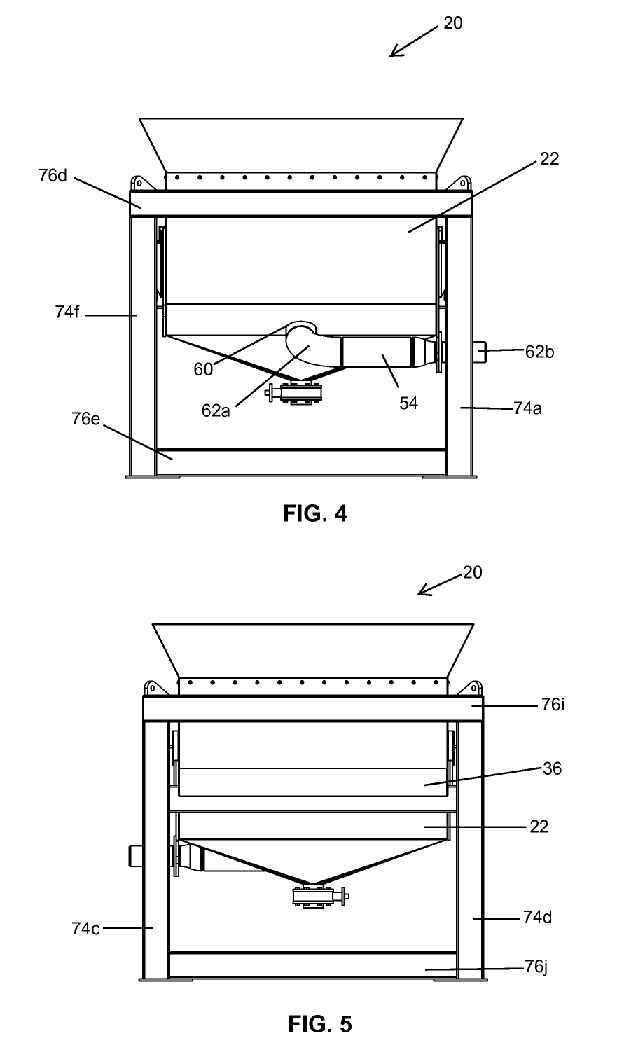

In the illustrated embodiment, container 22 is supported by frame 50. Frame 50 comprises a plurality of vertical members 74a, 74b, 74c, 74d, 74e, and 74f, and a plurality of horizontal members 76a, 76b, 76c, 76d, 76e, 76f, 76g, 76h, 76i, 76j, 76k, and 76l which are welded or otherwise fastened together to form an open, box-like structure for supporting container 22 as shown in FIGS. 2-5. Horizontal members 76b, 76k (FIGS. 2) and 76g, 76l (FIG. 3) form cross members 51. Container 22 is movably or pivotally mounted to frame 50 via a plurality of pivot members 52 that are mounted to cross members 51, with container 22 including mounts 53 connected or engaged with pivot members 52 to support container 22 on pivot members 52. A motor 77 (FIGS. 2 and 3), may be used to reciprocate container 22 relative to frame 50 via pivot members 52. This creates a wave-like motion or oscillation in the slurry material contained in cavity 28, which helps to separate out the heavier minerals and discharge the lighter material down chute 36.

In the illustrated embodiment, pivot members 52 support movement along a longitudinal axis only. However, it is envisioned that movement along a transverse axis or dual axis movement could also be supported.

Located at the upper corners of frame 50 are tabs 78 having through-holes 80. Tabs 78 serve as attachment points when lifting or tying down apparatus 20 during transportation.

As shown in FIGS. 7-11, apparatus 20 may further include a series of security panels 82a, 82b, 82c, 82d, 82e, 82f, 82g, and 82h over the open regions in the sides and top of frame 50. Security panels 82a-82h help prevent unauthorized access to the precious material collected in funnel 46. Panels 82a-82h also protect against injury by covering potential pinch points. In the preferred embodiment, side panels 82a-82d and front panel 82e include a piano hinge on one side and an electromagnetic lock on an opposite side so the panel may be opened by an authorized person to retrieve material from funnel 46 through valve 48 or for maintenance and repairs. Optionally, other locking devices may be used, such as a conventional key lock, a pad lock or the like. Panels 82f-82h are intended to remain closed and are hinged on one side and bolt from behind on an opposite side. Panel 82a includes a through-hole opening 84 for receiving distal end 62b of inlet pipe 54 so that a water supply may be connected to pipe 54 while panel 82a is secured in place. Panel 82c includes a user interface portion 83 for controlling and monitoring the operation of apparatus 20. Interface portion 83 may additionally include a lock for securing the interior of apparatus 20 from unauthorized entrance.

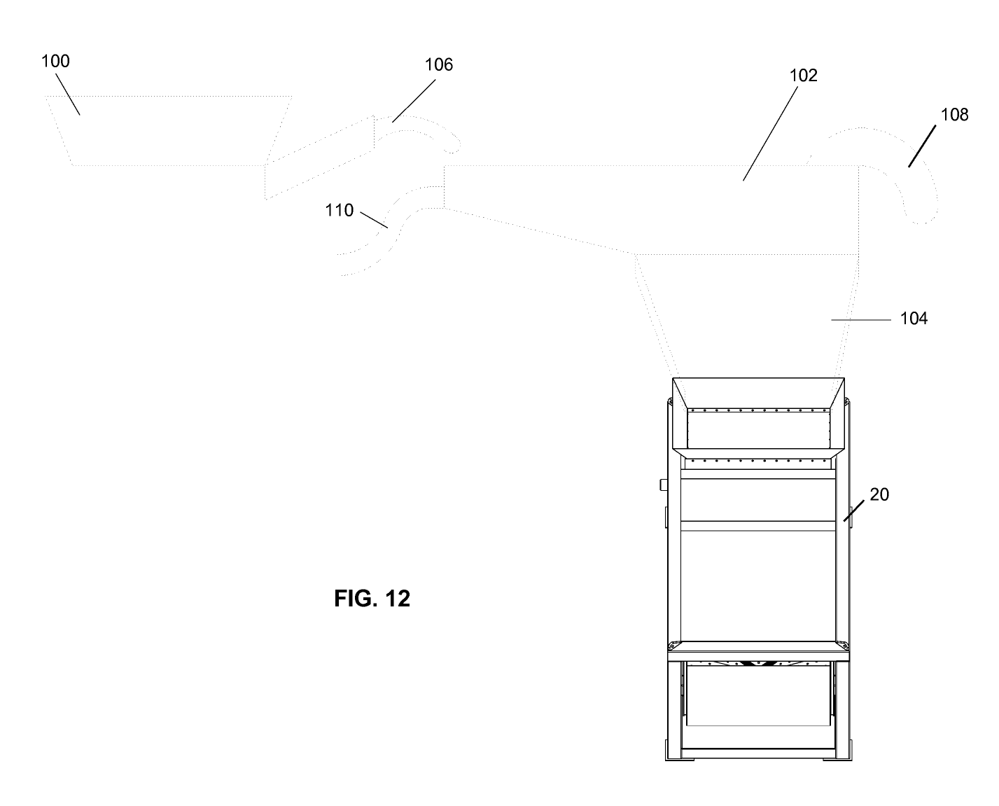

Heavy metal recovery apparatus 20 may be used as a stand-alone system to recover precious minerals such as gold directly from mined earth. Optionally, apparatus 20 may be used in combination with additional heavy metal recovery or mining equipment as part of a system to process the slurry material discharged from the mining equipment, such as a hydraulic mining system, to recover residual precious minerals that were missed as a result of inefficiencies in the mining operation and that would otherwise be discarded. As shown in FIG. 12, a typical hydraulic mining system for mining gold includes a feeder 100, a trommel wash plant or shaker 102, and a sluice box 104. Feeder 100 receives mined earth, typically at a rate of up to 180 yards per hour. Feeder 100 separates out large boulders and rocks while earth and smaller rocks 106 are fed from feeder 100 into wash plant 102. In wash plant 102, earth 106 from feeder 100 is combined with water supplied to wash plant 102 via hose 110 at a rate of up to 3,000 gallons per minute. Wash plant 102 separates out solid material 108 larger than approximately one inch in diameter. The remaining earth and water mixture exits wash plant 102 and flows down sluice box 104 where gravity separation is used to recover the heavier minerals, such as via the inclusion of miners moss within sluice box 104. The slurry material discharged from sluice box 104 is input into hopper 34 of apparatus 20 where any residual heavy minerals are separated from the lighter waste material for collection from funnel 46 as described above.

Apparatus 20 may be secured from tampering by way of security panels 82 to prevent theft of precious metals recovered therein. In use, apparatus 20 may be operated for an extended period of time covering multiple days or weeks, with authorized personnel then periodically gaining access to the internal portions of apparatus 20 by opening an electromagnetic lock, or the like, and subsequently opening valve 48 to remove precious metals collected within funnel 46. Thus, apparatus 20 can be provided to a mining operator for incorporation to or with existing heavy metal recovery equipment, such as shown in FIG. 12. In a particular arrangement, a separate party having rights to apparatus 20 may provide apparatus 20 to a mining operator for incorporation into an existing system, such as a system with a first or primary recovery system, apparatus or method, such as one including a sluice box 104, with apparatus 20 being used to recover precious metals as part of a secondary processing system or operation that would otherwise be discarded through the primary processing operation or equipment or system. That is, the secondary processing system receives the discharge from the primary recovery system. Portioning of the recovered precious heavy metals in the secondary processing may then be made between the parties.

Therefore, the present invention provides an apparatus for recovering gold and other precious minerals contained in a slurry mixture based on the different settling rates of the material in the mixture. The apparatus includes a separating container having a bottom element with a plurality of apertures that allow for the introduction of a low pressure fluid into the container to aid in the material separation process. Lighter waste material rises in the slurry mixture and is discarded while the heavier metals and precious minerals settle to the bottom for later retrieval. The present invention has particular benefit when used at the discharge end of a sluice box or the like to recover residual precious metals missed by the earlier processing.

Changes and modifications to the specifically described embodiments may be carried out without departing from the principles of the present invention, which is intended to be limited only by the scope of the appended claims as interpreted according to the principles of patent law including the doctrine of equivalents.

The embodiments of the invention in which an exclusive property is claimed are defined as follows:

1. A heavy metal recovery apparatus comprising:
a container having a cavity defined by a bottom element and a wall extending upwards from the bottom element, wherein the container has an input end and an output end, and wherein the bottom element includes a plurality of apertures therethrough, wherein the bottom element comprises an upper portion and a lower portion with a chamber therebetween, and wherein the plurality of apertures are incorporated into the upper portion, and wherein the bottom element slopes downward from the input end to the output end.

2. The apparatus of claim 1 further comprising a collection funnel, wherein the funnel is incorporated into the bottom element with the funnel being disposed at the output end and extending downward from a plane defined by the bottom element.

3. The apparatus of claim 2 wherein the funnel includes a funnel upper portion and a funnel lower portion with the chamber extending into the funnel.

4. The apparatus of claim 3 wherein the funnel upper portion includes a plurality of apertures therethrough.

5. The apparatus of claim 2, further comprising an input hopper positioned at the input end of the container and a discharge chute positioned at the output end of the container, and wherein the discharge chute is vertically elevated relative to the funnel.

6. The apparatus of claim 1, further comprising a motor and a frame with the container being mounted to the frame by pivot mounts and the motor configured to oscillate the container relative to the frame.

7. The apparatus of claim 6, further comprising an input hopper positioned at the input end of the container and a discharge chute positioned at the output end of the container further and comprising a plurality of panels mounted to the frame to substantially and securely enclose the container within the frame whereby only the input hopper and discharge chute are exposed.

8. The apparatus of claim 7 further including a locking mechanism engaged with at least one of the panels to control access to the container.

9. The apparatus of claim 1 wherein pneumatic diffusers are disposed in the apertures.

10. A method of recovering heavy metals, the method comprising:
supplying a slurry mixture into a cavity of a container, the container having a bottom element with a plurality of apertures therethrough, wherein the bottom element of the container comprises an upper portion and a lower portion with a chamber therebetween, and wherein the plurality of apertures are incorporated into the upper portion, and wherein the bottom element slopes downward from an input end to an output end;
introducing a fluid into the container through the plurality of apertures;
removing lower density materials that rise toward the top of the slurry mixture; and
removing higher density materials that settle to the bottom element.

11. The method of claim 10, further comprising oscillating the container.

12. The method of claim 10 wherein the container further includes a collection funnel, wherein the funnel is incorporated into the bottom element with the funnel being disposed at the output end and extending downward from a plane defined by the bottom element.

13. The method of claim 12 wherein the funnel includes a funnel upper portion and a funnel lower portion with the chamber extending into the funnel, and wherein the funnel upper portion includes a plurality of apertures therethrough.

14. The method of claim 12 wherein removing higher density materials comprises removing higher density materials from the funnel and wherein the funnel includes a valve disposed at a discharge portion of the funnel.

15. The method of claim 10, wherein the slurry mixture supplied to the cavity of the container is an output of a separate recovery process.

16. The method of claim 15, wherein the slurry mixture supplied to the cavity is an output of a sluice box, and wherein said supplying a slurry mixture into a cavity of a container comprises discharging a slurry mixture from said sluice box into the cavity of the container.

17. The method of claim 10, wherein said container is mounted to a frame and panels are mounted to said frame to substantially enclose said container.

18. A heavy metal recovery method, said method comprising:
processing earth material using a first recovery system to separate heavy metals from the earth material;
discharging earth material from the first recovery system into a container;
processing the earth material discharged from the first recovery system in the container to separate heavy metals remaining in the earth material discharged from the first recovery system, wherein processing the earth material discharged from the first recovery system comprises flowing the earth material discharged from the first recovery system through the container;
wherein the container comprises a cavity defined by a bottom element and a wall extending upwards from the bottom element, wherein the container has an input end and an output end, and wherein the bottom element includes a plurality of apertures therethrough, wherein the bottom element comprises an upper portion and a lower portion with a chamber therebetween, and wherein the plurality of apertures are incorporated into the upper portion, and wherein the bottom element slopes downward from the input end to the output end;
wherein the container further comprises an input hopper positioned at the input end of the container and a discharge chute positioned at the output end of the container, and wherein the bottom element of the container includes a collection chamber; and
wherein the container further comprises a frame, with the container being movably mounted to the frame by pivot mounts and with a plurality of panels mounted to the frame to substantially and securely enclose the container within the frame whereby only the input hopper and discharge chute are exposed.

19. The heavy metal recovery method of claim 18, wherein the first recovery system comprises a sluice box and wherein the earth material discharged from the first recovery system comprises a slurry mixture supplied to the input hopper of the container.

20. The heavy metal recovery method of claim 18, wherein the collection chamber comprises a collection funnel, wherein the funnel is incorporated into the bottom element with the funnel being disposed at the output end and extending downward from a plane defined by the bottom element, and wherein a valve is connected to said funnel to selectively enable removal of heavy metal disposed in the funnel.
